(19) United States
(12) Patent Application Publication
(10) Pub. No.: US 2007/0132240 A1
(43) Pub. Date: Jun. 14, 2007

(54) Fluid line connector assembly with antimicrobial coating

(76) Inventor: Evan J Segal, Pittsburgh, PA (US)

Correspondence Address: Fay Sharpe Fagan Minnich & McKee, 1100 Superior Avenue, 7th Floor, Cleveland, OH, 44114, US

(21) Appl. No.: 10/514,918

(22) PCT Filed: May 14, 2003
(86) PCT No.: PCT/US03/14992

§ 371 Date: Nov. 15, 2004

Related U.S. Application Data
(60) Provisional application No. 60/380,767, filed on May 15, 2002.

(51) Int. Cl. F16L 25/00

(52) U.S. Cl. 285/386

(57) ABSTRACT

A fluid line connector assembly including a length of flexible tubing having opposing tubing ends, and an end fitting rotatably supported on one of the tubing ends. A flexible coating extends along the exterior of the length of tubing. The coating is formed from a polymeric material that includes a biocide agent dispersed therein for killing and retarding the growth of microorganisms. The connector assembly can optionally include a braided sheath extending along the exterior of the length of tubing. In such case, the flexible coating extends along the exterior of the braided sheath.

### BACKGROUND OF THE INVENTION

This invention relates to the art of fluid line connector assemblies and, more particularly, to thin-walled, flexible fluid line connector assemblies for use in low-pressure applications, such as for connecting between a gas supply line and a stationary or movable gas appliance, a commercial fryer, for example.

Thin-walled, flexible fluid line connector assemblies have been provided heretofore and generally include a length of thin-walled, corrugated, flexible tubing having opposing non-corrugated tubing ends and a fluid-tight fitting arrangement on at least one of the tubing ends. Known connector assemblies commonly include a fitting arrangement on each tubing end. These fitting arrangements commonly include threaded connectors, quick-connect fittings and/or multi-plane swivel fittings, either alone or in any one of numerous combinations.

For example, one such known connector assembly includes a flare nut retained on each tubing end and a flare fitting cooperable with each flare nut to form a fluid-tight seal therewith. The tubing ends have a generally cylindrical journal portion and a radially outwardly extending flare portion, with the cylindrical journal portion spaced axially inwardly from the flare portion. The flare nuts are retained on the non-corrugated tubing ends by the flare portion, which is deformed radially outwardly after assembly with the flare nut to engage the flare nut and thereby prevent removal thereof from the length of tubing. To form a fluid-tight seal between the flare nut and the flexible tubing, a flare fitting is threadably engaged into the flare nut. The flare fitting includes a frustoconical leading surface, which compressively engages the flare portion of the tubing end. As the flare fitting and flare nut are threadably tightened together, the frustoconical leading surface of the flare fitting displaces the flare portion of the flexible tubing against an interior surface of the flare nut. This displacement causes the flare portion of the tubing to be compressively engaged between the flare fitting and flare nut, and causes a metal-to-metal seal to form between the tubing, the flare fitting and the flare nut such that the assembly becomes fluid tight.

Fluid line connector assemblies of the foregoing nature may also include a braided sheath supported on the outside of the flexible tubing. The braided sheath may be secured to the length of flexible tubing adjacent the tubing ends by any suitable method. For example, a cylindrical inner collar may be fitted onto the cylindrical journal portion of the tubing end prior to the formation of the flare portion. An end of the braided sheath may then be positioned along a portion of the outer surface of the inner collar. A braid retaining collar can then be positioned radially adjacent the braided sheath opposite the inner collar, and crimped radially inwardly to compressively capture the braid against the inner collar. Alternatively, the end of the braided sheath may be soldered, brazed, welded or otherwise fused to a portion of the flexible tubing. The flare nut is then assembled onto each of the tubing ends, which are thereafter deformed radially outwardly to engage the flare nut and thereby prevent removal from the length of tubing.

Additionally, known fluid line connector assemblies commonly include a flexible coating layer extending along the exterior of the length of flexible tubing between the opposing tubing ends. The flexible tubing layer provides a relatively smooth and cleanable outer surface along the length of the flexible tubing. This smoother surface is useful in installations, such as food service applications, where a sanitary environment is maintained. In such environments, the fluid line connector assembly is often regularly sanitized. The relatively smooth outer surface of the flexible coating layer, which extends along the length of flexible tubing, is considerably more cleanable than the corrugated, flexible tubing or the braided sheath commonly used to cover the corrugated flexible tubing.

A disadvantage of connector assemblies having a flexible coating layer is that the conditions giving rise to the need for regular sanitization of the fluid line connector assembly also promote the growth of microorganisms, such as fungi, bacteria, mold and mildew. These microorganisms attack the flexible coating layer often causing undesirable changes in the observable characteristics of the connector assembly, such as discoloration, tackiness and even foul odor. Furthermore, the deterioration of physical and mechanical properties of the coating layer and a corresponding overall reduction in product life often result from the continued re-growth of these microorganisms.

Additionally, connector assemblies are commonly cleaned or sanitized with harsh chemical agents. Such chemical agents may also contribute to the degradation of the appearance of the connector assembly, as well as the deterioration of the physical and mechanical properties of the flexible coating layer. As a result, the repeated exposure to these chemical agents contributes to an overall reduction in the life of the connector assembly. As such, any reduction in the growth of microorganisms or duration of exposure to sanitization chemicals is beneficial.

### BRIEF SUMMARY OF THE INVENTION

In accordance with the present invention, a thin-walled, flexible- fluid line connector assembly is provided that avoids or minimizes the problems and difficulties encountered in connection with connector assemblies of the foregoing nature, while promoting an increase in performance and reliability and maintaining a desired simplicity of structure, economy of manufacture, as well as ease of installation and maintenance.

More particularly in this respect, a fluid line connector assembly is provided for use in connecting between two fluid transmission lines or a fluid transmission line and an appliance or other device, such as between a gas supply line and a commercial, gas fryer. The fluid line connector assembly includes a length of flexible tubing having opposing tubing ends, at least one of the opposing tubing ends is substantially cylindrical and has an end fitting supported and retained thereon, and a flexible coating layer extending along the exterior of the length of flexible tubing between opposing tubing ends. The flexible coating layer formed from a polymeric material having a biocide dispersed throughout the material for killing microorganisms and inhibiting the re-growth thereof.

Additionally, a fluid line connector assembly is provided for use in connecting between two fluid transmission lines or a fluid transmission line and an appliance or other device, such as between a gas supply line and a commercial, gas fryer. The fluid line connector assembly includes a length of flexible tubing having opposing tubing ends, at least one of which is substantially cylindrical and includes end fitting supported and retained thereon, a braided sheath extending along the exterior of the flexible tubing, and a flexible coating layer extending along the exterior of the braided sheath between opposing tubing ends. The flexible coating layer formed from a polymeric material having a biocide dispersed throughout the material for killing microorganisms and inhibiting the re-growth thereof

### BRIEF DESCRIPTION OF THE DRAWINGS

FIG. 1 is a partial cross-sectional view of a fluid line connector assembly in accordance with the present invention.

FIG. 2 is a partial cross-sectional view of an alternate embodiment of a fluid line connector assembly in accordance with the present invention.

### DETAILED DESCRIPTION OF THE INVENTION

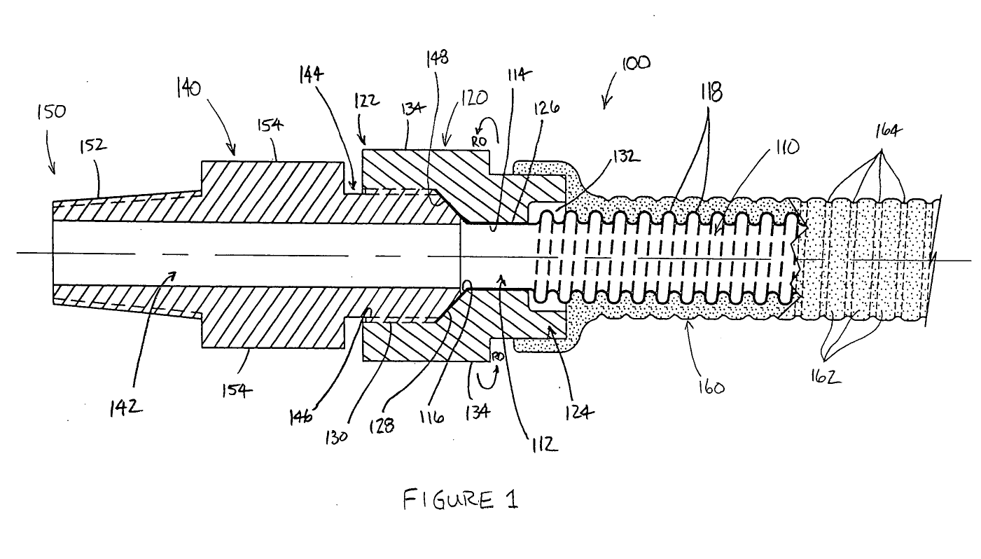

Referring now in greater detail to FIG. 1, wherein the showings are for the purposes of illustrating preferred embodiments of the invention only and not for the purpose of limiting the invention, FIG. 1 illustrates a fluid line connector assembly 100 that includes a length of thin-walled flexible tubing 110 having a plurality of helical corrugations 118 extending between opposing tubing ends 112, a flare nut 120 supported on at least one of the tubing ends, a flare fitting 140 cooperable with the flare nut, and a flexible coating layer 160 extending between the opposing ends. It will be appreciate that only one end of fluid line connector assembly 100 is shown in FIG. 1.

Tubing end 112 includes a cylindrical journal portion 114 and a flare portion 116. Flare nut 120 includes a journal passage 126 cooperable with journal portion 114, such that the flare nut is receivingly engaged upon tubing end 112. Flare nut 120 includes a threaded end 122 and a recess end 124 having an annular recess 132. Flare nut 120 is positioned on tubing end 112 such that recess 132 receivingly engages a portion of one or more tubing corrugations 118. Extending radially outwardly from journal passage 126 toward threaded end 122 is flare seat 128. Female threads 130 extend into flare nut 120 from threaded end 122. Opposing wrench flats 134 are provided along the exterior of the flare nut.

Flare fitting 140 includes a threaded end 144 and a connector end 150 opposite the threaded end. A fluid passage 142 extends through flare fitting 140. Threaded end 144 includes male threads 146 and a flare-engaging surface 148. Male threads 146 are cooperable with female threads 130 of flare nut 120. Flare fitting 140 includes connector threads, shown as male threads 152 in FIG. 1, along connector end 150. Opposing wrench flats 154 are provided between ends 144 and 150.

Flexible coating layer 160 extends along the exterior of flexible tubing 110 between opposing flare nuts 120. It is desirable for the end fittings on the connector assembly, such as flare nut 120, to remain rotatable after the coating layer is applied, as indicated by arrow RO. Commonly, coating layer 160 will at least partially conform to the exterior surface of tubing 110 such that helically extending grooves 164 are formed in the coating layer that correspond to tubing corrugations 118 of tubing 110. A biocide agent 162 is distributed throughout coating layer 160. It will be appreciated that the biocide agent is shown in FIG. 1 at an increased scale for purposes of illustration. It will be further appreciated that FIG. 1 is not intended to illustrate a specific proportion or distribution pattern of biocide agent within the coating layer.

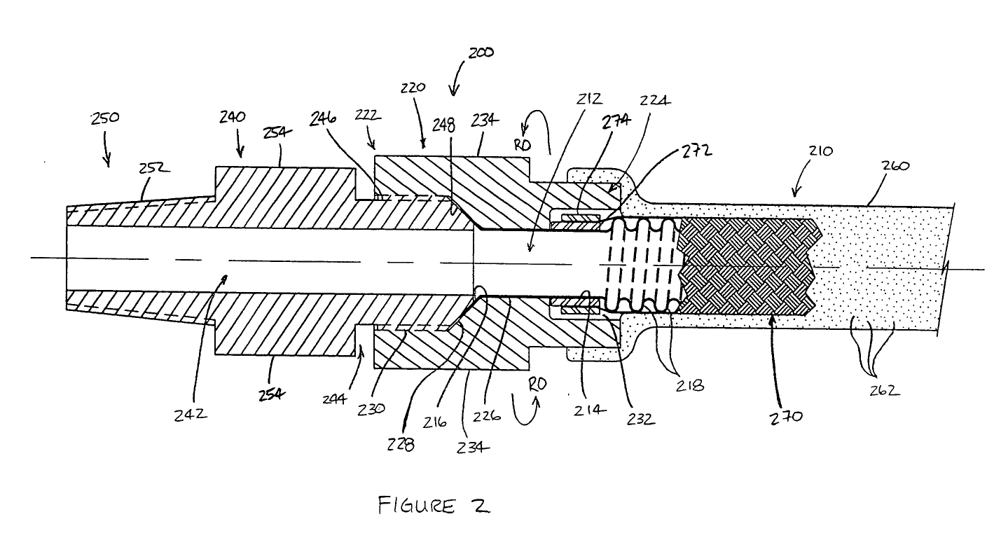

FIG. 2 illustrates an alternate embodiment of the fluid connector assembly shown in FIG. 1. Unless otherwise indicated, the items in FIG. 2 correspond to those illustrated and discussed with respect to FIG. 1. However, the items in FIG. 2 include reference numerals incremented by 100. Items shown in FIG. 2 having no counterpart in FIG. 1 will be distinctly pointed out and discussed hereinafter.

FIG. 2 illustrates an alternate embodiment of a fluid line connector assembly 200 in accordance with the present invention. The connector assembly includes a length of flexible tubing 210 having opposing tubing ends 212, a flare nut 220, a flare fitting 240 and a flexible coating layer 260. Connector assembly 200 further includes a braided sheath 270 extending along the length of flexible tubing 210 between opposing flare nuts 220. An inner collar 272 is receivingly engaged on cylindrical journal portion 214 of tubing end 212. A portion of braided sheath 270 extends along the exterior of inner collar 272, and braided retaining collar 274 is positioned adjacent the sheath radially opposite inner collar 272. Braid retaining collar 274 is crimped or otherwise radially inwardly deformed to compressively retain braided sheath 270 between the two collars.

Flexible coating layer 260 extends along the exterior of connector assembly 200 over braided sheath 270. It is desirable for the end fittings on the connector assembly, such as flare nut 120, to remain rotatable after the coating layer is applied, as indicated by arrow RO. It will be appreciated that braided sheath 270 forms a substantially cylindrical surface relative to corrugations 218, such that the flexible coating layer also has a relatively smooth surface without the helically extending grooves illustrated in the embodiment shown in FIG. 1. Flexible coating layer 260 includes a biocide agent 262 distributed throughout the layer. It will be appreciated that the biocide agent is shown in FIG. 2 at an increased scale for purposes of illustration. It will be further appreciated that FIG. 2 is not intended to illustrate a specific proportion or distribution pattern of biocide agent within the coating layer.

Flexible coating layers 160 and 260, respectively illustrated in FIGS. 1 and 2, are formed from a polymeric material having a biocide agent distributed throughout the material. In the present embodiment, these flexible coating layers are formed from a base material of diisodecyl phthalate and polyvinyl chloride. Zinc pyrithione is distributed in the base material as a biocide agent. Over time, the zinc pyrithione migrates through the base material to the surface of the coating layer to kill microorganisms and inhibit the growth thereof.

In a preferred embodiment, the flexible coating layer includes zinc pyrithione at between about one (1) to about twenty (20) percent by weight, preferably at between about two (2) to about ten (10) percent by weight, and more preferably at about four (4) to about six (6) percent by weight. Diisodecyl phthalate is included at between about fifty (50) to about eighty (80) percent by weight, preferably at between about fifty-five (55) to about seventy-five (15) percent by weight, and more preferably at between about sixty (60) to about seventy (70) percent by weight. Polyvinyl chloride is included at between about fifteen (15) to about forty-nine (49) percent by weight, preferably at between about twenty (20) to about forty (40) percent by weight, and more preferably at between about twenty-five (25) to about thirty-five (35) percent by weight. The zinc pyrithione includes zinc at between about ten (10) percent to about thirty (30) percent by weight, preferably between about fifteen (15) percent to about twenty-five (25) percent by weight, and more preferably, between about nineteen (19) percent to about twenty-two (22) percent by weight.

One suitable polymeric material formed from diisodecyl phthalate and polyvinyl chloride that includes zinc pyrithione is available under the trademark INTERCIDE® ZnP-5 DIP from Akcros Chemicals America, New Brunswick, New Jersey. This material includes diisodecyl phthalate at between about sixty (60) to about seventy (70) percent by weight, polyvinyl chloride at between about twenty-five (25) to about thirty-five (35) percent by weight, and zinc pyrithione at between about four (4) to about six (6) percent by weight. The zinc pyrithione includes zinc at about 20.6 percent by weight.

It will be appreciated, however, that biocide agents are generally well known and other suitable agents may be used. What's more, a single biocide agent or a mixture of biocide agents may be used to achieve the desired level of effectiveness. Particular examples of biocide agents include phytochemicals such as capsaicinoids, grapefruit seed extract, Lemon Grass Oil, Tea Tree Oil, citric acid, Vitamin E and various other antimicrobial agents that are believed to be safe for human handling and contact, such as trichloromelamine, quaternary ammonium compounds and/or zinc pyrithione. It will be further appreciated that biocide agents can be dispersed in other polymeric materials. For example, such materials may include silicone-based materials, polyolefin-based materials, synthetic rubber or other suitable materials.

While the invention has been described with reference to the preferred embodiments and considerable emphasis has been placed herein on the structures and structural inter-relationships between the component parts of the embodiments disclosed, it will be appreciated that other embodiments of the invention can be made and that many changes can be made in the embodiments illustrated and described without departing from the principles of the invention. Obviously, modifications and alterations will occur to others upon reading and understanding the preceding detailed description. For example, numerous end fittings and end fitting configurations are known in the art, such as threaded fittings, quick-connect end fittings and multi-plane swivel connectors, which may be provided on one of the tubing ends, either alone or in combination with one another. Accordingly, it is to be distinctly understood that the foregoing descriptive matter is to be interpreted as merely illustrative of the present invention and not as a limitation. As such, it is intended that the invention will be construed as including all such modifications and alterations insofar as they come within the scope of the appended claims and the equivalents thereof.

We claim:

1. A fluid line connector assembly comprising:
a length of flexible tubing having opposing tubing ends;
an end fitting rotatably supported on one of said tubing ends; and,
a flexible coating extending along the exterior of said length of tubing between said tubing ends, said flexible coating formed from a polymeric material comprising a biocide agent for killing and retarding the growth of microorganisms.

2. The invention of claim 1, wherein said polymeric material comprises from about one (1) percent to about twenty (20) percent by weight zinc pyrithione as said biocide agent.

3. The invention of claim 2, wherein said polymeric material comprises from about two (2) percent to about ten (10) percent by weight zinc pyrithione as said biocide agent.

4. The invention of claim 3, wherein said polymeric material comprises from about four (4) percent to about six (6) percent by weight zinc pyrithione as said biocide agent.

5. The invention of claim 2, wherein said polymeric material further comprises from about fifteen (15) percent to about forty-nine (49) percent by weight polyvinyl chloride.

6. The invention of claim 5, wherein said polymeric material further comprises from about twenty (20) percent to about forty (40) percent by weight polyvinyl chloride.

7. The invention of claim 6, wherein said polymeric material further comprises from about twenty-five (25) percent to about thirty-five (35) percent by weight polyvinyl chloride.

8. The invention of claim 5, wherein said polymeric material further comprises from about fifty (50) percent to about eighty (80) percent by weight diisodecyl phthalate.

9. The invention of claim 8, wherein said polymeric material further comprises from about fifty-five (55) percent to about seventy-five (75) percent by weight diisodecyl phthalate.

10. The invention of claim 9, wherein said polymeric material further comprises from about sixty (60) percent to about seventy (70) percent by weight diisodecyl phthalate.

11. A fluid line connector assembly comprising:
a length of flexible tubing having opposing tubing ends;
an end fitting rotatably supported on one of said tubing ends;
a braided sheath extending between said tubing ends; and,
a flexible coating extending along the exterior of said braided sheath, said flexible coating formed from a polymeric material comprising a biocide agent for killing and retarding the growth of microorganisms.

12. The invention of claim 11, wherein said polymeric material comprises from about one (1) percent to about twenty (20) percent by weight zinc pyrithione as said biocide agent.

13. The invention of claim 12, wherein said polymeric material comprises from about two (2) percent to about ten (10) percent by weight zinc pyrithione as said biocide agent.

14. The invention of claim 13, wherein said polymeric material comprises from about four (4) percent to about six (6) percent by weight zinc pyrithione as said biocide agent.

15. The invention of claim 11, wherein said biocide agent comprises from about ten (10) percent to about thirty (30) percent zinc.

16. The invention of claim 15, wherein said biocide agent comprises from about fifteen (15) percent to about twenty-five (25) percent zinc.

17. The invention of claim 16, wherein said biocide agent comprises from about nineteen (19) to about twenty-two (22) percent zinc.

18. An improved fluid line connector assembly including a length of flexible tubing having opposing tubing ends, an end fitting rotatably supported on one of said tubing ends, and a flexible coating extending along the exterior of said length of tubing, the improvement comprising:
said flexible coating formed from a polymeric material comprising a biocide agent for killing and retarding the growth of microorganisms.

19. The invention of claim 18, wherein said biocide agent is selected from the group consisting of phytochemicals, capsaicinoids, grapefruit seed extract, Lemon Grass Oil, Tea Tree Oil, citric acid, Vitamin E, trichloromelamine, quaternary ammonium compounds, pyrithione and combinations thereof.

20. The invention of claim 19, wherein said polymeric material comprises a base material selected from the group consisting of polyvinyl chloride, silicone, polyolefins and synthetic rubber.
